(19) United States
(12) Patent Application Publication
(10) Pub. No.: US 2009/0211375 A1
(43) Pub. Date: Aug. 27, 2009

(54) Load detection apparatus

(75) Inventor: Hajime Nakagawa, Nagoya-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/378,787

(22) Filed: Feb. 19, 2009

(30) Foreign Application Priority Data
Feb. 21, 2008 (JP) 2008-040316

(51) Int. Cl. G01L 1/22

(52) U.S. Cl. 73/862.045

(57) ABSTRACT

An apparatus for detecting a load is disclosed. The apparatus includes a printed circuit board having a wiring pattern. The apparatus further includes a load sensing element located on the printed circuit board and including a pressure-sensitive member. The pressure-sensitive member has an electric property that is changeable according to the load. The apparatus further includes a load detection circuit arranged on the printed circuit board, connected with the load sensing element through the wiring pattern of the printed circuit board, and configured to detect a detection result of the load based on a change in the electric property of the load sensing element.

### CROSS REFERENCE TO RELATED APPLICATION

The present application is based on Japanese Patent Application No. 2008-40316 filed on Feb. 21, 2008, the disclosure of which is incorporated herein by reference.

### BACKGROUND OF THE INVENTION

1. Field of the Invention

The present invention relates to a load detection apparatus for detecting a load.

2. Description of Related Art

JP-A-H6-137806 recites a strain sensor for sensing a load. The strain sensor includes a metal base having a thin plate shape, an insulating layer, and a resistance element. The insulating layer is formed on the metal base. The resistance element is formed on the insulating member and arranged in a predetermined pattern. When a load is applied to the strain sensor, the metal base is strained and the resistance element is accordingly strained. The strain of the resistance element changes a resistance thereof.

A load detection apparatus may be configured by using the above strain sensor and a load detection circuit for detecting a load based on a change in resistance of the strain sensor. As described above, a load strains the metal base and changes a resistance of the resistance element of the strain sensor. When the metal base is made smaller, since the metal base cannot be strained sufficiently, the change in resistance becomes smaller. It becomes therefore difficult to downsize the metal base, and as a result, difficult to downsize the strain sensor. When a load detection apparatus employs the above strains sensor, it becomes difficult to downsize the load detection apparatus.

### SUMMARY OF THE INVENTION

In view of the above and other points, it is an objective of the present invention to provide an apparatus for detecting a load.

According to a first aspect of the present invention, an apparatus for detecting a load is provided. The apparatus includes a printed circuit board having a wiring pattern. The apparatus further includes a load sensing element located on the printed circuit board and including a pressure-sensitive member. The pressure-sensitive member has an electric property that changes according to the load applied to the pressure-sensitive member. The apparatus further includes a load detection circuit arranged on the printed circuit board, connected with the load sensing element through the wiring pattern of the printed circuit board, and configured to detect the load based on a change in the electric property of the load sensing element.

According to the above configuration, it is possible to downsize an apparatus for detecting a load.

According to a second aspect of the present invention, an apparatus for detecting a load is provided. The apparatus includes a ceramic printed circuit board having first and second surface opposite to each other. The ceramic printed circuit board includes first and second resistor layers each located on the first surface of the ceramic printed circuit board. Each of the first and second resistor layers has a resistance that is changeable according to the load applied thereto and temperature thereof. The ceramic printed circuit board includes a third resistor layer located on the first surface of the ceramic printed circuit board and having a resistance that is changeable according to temperature thereof. The apparatus further includes first and second pressure receivers. The first and second pressure receivers are respectively coupled with the first and second pressure-sensitive resistor layers, and are configured to receive the load from outside and apply the received load to the first and second pressure-sensitive resistor layers, respectively. The apparatus further includes a load detection IC mounted onto the first surface of the ceramic printed circuit board so that first and second pressure-sensitive resistor layers are arranged in a symmetric manner about the load detection IC. The load detection IC is electrically connected with the first and second pressure-sensitive resistor layers and the temperature compensating resistor layer. The load detection IC is is configured to detect the load based on a change in resistance of the first and second pressure-sensitive resistor layers while compensating the change in resistance of the first and second pressure-sensitive resistor layers based on a change in resistance of the temperature compensating resistor layer.

According to the above configuration, it is possible to downsize an apparatus for detecting a load.

### BRIEF DESCRIPTION OF THE DRAWINGS

The above and other objects, features and advantages of the present invention will become more apparent from the following detailed description made with reference to the accompanying drawings. In the drawings:

FIG. 1 is a perspective view of a load detection apparatus according to an example embodiment;

FIG. 2 is a top view of a load detection apparatus according to an example embodiment;

FIG. 3 is a front view of a load detection apparatus according to an example embodiment;

FIG. 4 is a diagram for explaining an operation of a load detection apparatus according to an example embodiment;

FIG. 5 is a top view of a load detection apparatus according to a first modification;

FIG. 6 is a front view of a load detection apparatus according to a first modification;

FIG. 7 is a top view of a load detection apparatus according to a second modification; and

FIG. 8 is a front view of a load detection apparatus according to a second modification.

### DETAILED DESCRIPTION OF THE EXEMPLARY EMBODIMENTS

### Example Embodiment

In the present embodiment, a load detection apparatus for detecting a operating force on a brake pedal of a vehicle is presented as one example of a load detection apparatus.

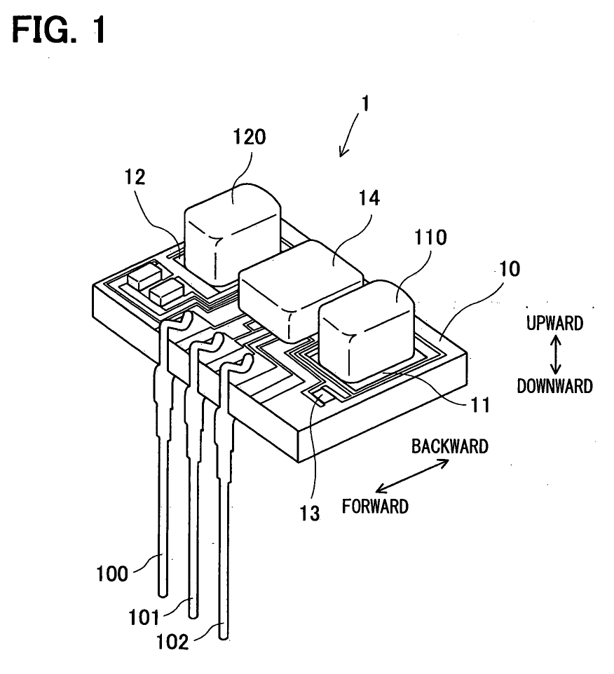

A configuration of a load detection apparatus is described below with reference to FIGS. 1 to 3. It should be noted that the forward, backward, upward and downward directions in the drawings merely play a descriptive role and do not constrain an actual orientation of a load detection apparatus.

As shown in FIGS. 1 to 3, a load detection apparatus 1 includes a ceramic printed circuit board 10, two pressure-sensitive resistors 11, 12, a temperature compensation resistor 13, a load detection integrated circuit (IC) 14. The ceramic printed circuit board 10 is an example of a printed circuit board. Each of the pressure-sensitive resistors 11, 12 is an example of a load sensing element. The temperature compensation resistor 13 is an example of a temperature compensation element. The load detection IC 14 is an example of a load detection circuit.

The ceramic printed circuit board 10 is made of ceramic, has a given rigidity, and has a generally rectangular plate shape. The pressure sensitive resistors 11, 12, the temperature compensation resistor 13 and the load detection IC 14 are arranged on and connected to the ceramic printed circuit board 10. The ceramic printed circuit board 10 has a predetermined wiring pattern on an upper surface of the ceramic printed circuit board 10. External connection terminals 100 to 102 for external connection are fixed to a front end part of the ceramic printed circuit board 10.

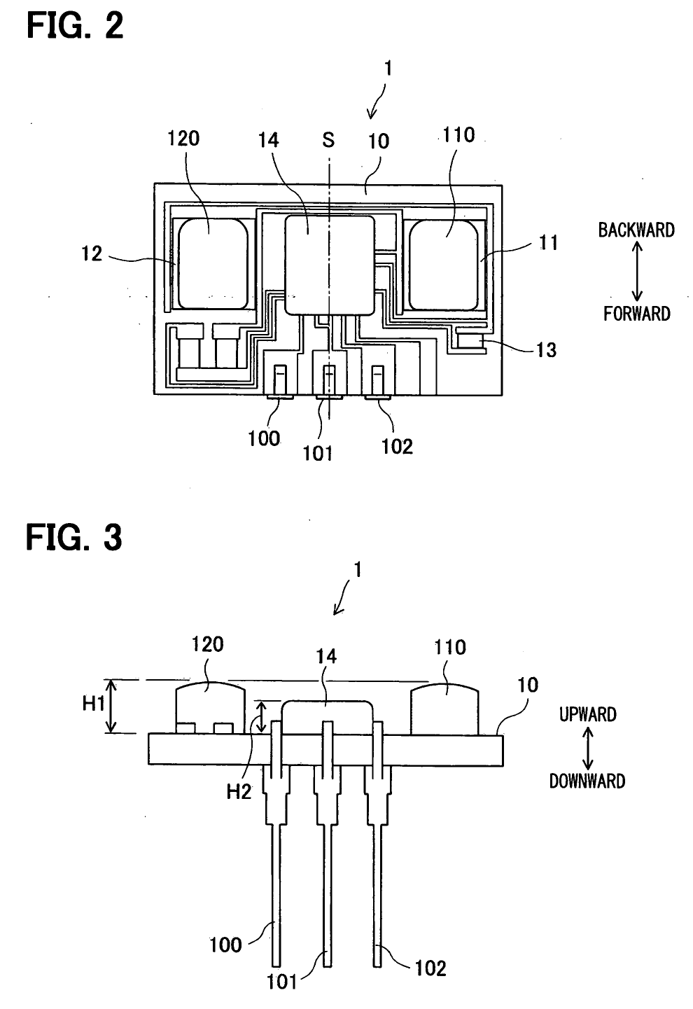

Each pressure-sensitive resistor 11, 12 is formed on the upper surface of the ceramic printed circuit board 10 and have a generally rectangular layer shape. The pressure-sensitive resistor 11, 12 has an electric property that is changeable according to a load applied. More specifically, the pressure-sensitive resistor 11, 12 includes a pressure-sensitive member, which has a resistance that is changeable according to a load applied thereto. As shown in FIG. 2, the pressure-sensitive resistors 11, 12 are line-symmetric about an axis “S” of symmetry. The axis of symmetry passes through a center part of the ceramic printed circuit board 10 and is parallel to a lateral direction of the ceramic printed circuit board 10. The center part of the ceramic printed circuit board 10 is a center part with respect to a longitudinal direction of the ceramic printed circuit board 10. The pressure-sensitive resistors 11, 12 are formed by, for example, screen printing. In the screen printing, a resistance material in the form of paste containing glass and RuO₂ particles having electric conductivity may be applied to the ceramic printed circuit board 10. As shown in FIG. 1, the pressure receivers 110, 120 are respectively fixed to upper portions of the pressure-sensitive resistors 11, 12. The pressure receivers 110, 120 can uniformly transmit an externally applied load to a wide region of the pressure-sensitive resistors 11, 12. Each pressure receiver 110, 120 is made of ceramic, has a generally rectangular box shape, and has a given rigidity. As shown in FIG. 3, a height H1 of each pressure receiver 110, 120 is set larger than a height H2 of the load detection IC mounted to the ceramic printed circuit board 10. When the external load is transmitted through the pressure receivers 110, 120 to the pressure-sensitive resistors 11, 12 on the ceramic printed circuit board 10, a resistance of each pressure-sensitive resistor 11, 12 changes.

As shown in FIGS. 1 and 2, the temperature compensation resistor 13 has a generally rectangular layer shape, and is formed on the upper surface of the ceramic printed circuit board 10. The temperature compensation resistor 13 has a resistance that changes according to temperature. The temperature compensation resistor 13 can be used for compensating temperature characteristics of the pressure-sensitive resistors 11, 12. The temperature compensation resistor 13 and the pressure-sensitive resistors 11, 12 are the same in material and temperature characteristic. However, unlike the pressure-sensitive resistors 11, 12, the temperature compensation resistor 13 does not include a pressure receiver. Thus, the temperature compensation resistor 13 does not receive an external load. The external load cannot be a cause for resistance change of the temperature compensation resistor 13. The temperature compensation resistor 13 is positioned in a predetermined region of the ceramic printed circuit board 10. The temperature compensation resistor 13 is formed by, for example, screen printing. In the screen printing, a pasty resistance material is applied to the ceramic printed circuit board 10 and the pasty resistance material is the same as for the pressure-sensitive resistors 11, 12.

The load detection IC 14 is mounted onto the upper surface of the ceramic printed circuit board 10. The load detection IC 14 includes a ceramic package and a circuit that can detect an applied load based on a change in resistance of the pressure-sensitive resistors 11, 12. More specifically, the load detection IC 14 compensates temperature characteristics of the pressure-sensitive resistors 11, 12 based on a resistance of the temperature compensation resistor 13. Further, the load detection IC 14 determines the applied load based on the above temperature-compensated resistances, converts the determined load into a predetermined signal, and outputs the predetermined signal. The load detection IC 14 is located between the pressure-sensitive resistors 11, 12 and on the axis “S” of symmetry. Input terminals of the load detection IC 14 are connected with the pressure-sensitive resistors 11, 12 and the temperature compensation resistor 13 through a wiring pattern formed in the ceramic printed circuit board 10. Output terminals of the load detection IC 14 are connected with the external connection terminals 100 to 102.

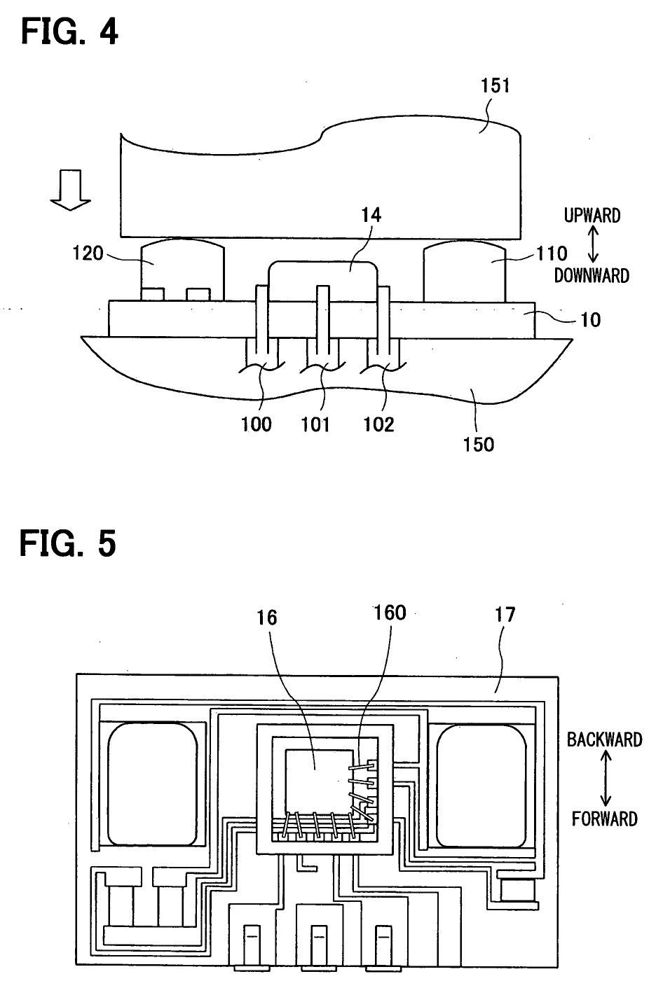

An operation of a load detection apparatus is described below with reference to FIGS. 1, 2 and 4. An outline arrow in FIG. 4 indicates a direction of an operating force on a load detection apparatus, which direction may be referred to hereinafter as a load direction. It should be noted that the forward, backward, upward and downward directions in the drawings merely play a descriptive role and do not constrain an actual orientation of a load detection apparatus.

As shown in FIG. 4, the ceramic printed circuit board 10 is fixed such that a lower surface of the ceramic printed circuit board 10 contacts a base member 150 of the vehicle. The pressure receivers 110, 120 are disposed such that the upper surfaces of the pressure receivers 110, 120 contact an operation force transmission member 15 for transmitting an operating force of the brake pedal. When the brake pedal is pressed down, the operating force is transmitted to the pressure receivers 110, 120 through the operation force transmission member 15. As a result, the pressure receivers 110, 120 are pressed in the downward direction. The load is applied through the pressure receivers 110 to the pressure-sensitive resistors 11, 12, which are exemplified in FIGS. 1, 2 and fixed to the pressure receivers 110, 120. Accordingly, the resistances of the pressure-sensitive resistors 11, 12 change. The load detection IC 14 compensates the temperature characteristics of the pressure-sensitive resistors 11, 12 based on the resistance of the temperature compensation resistor 13. Then, the load detection IC 14 determines the applied load, which corresponds to the operating force on the brake pedal, based on a change in temperature-compensated resistances. The load detection IC 14 converts the determined applied load into a predetermined signal and outputs the predetermined signal through the external output terminals 100 to 102.

Advantages of a load detection apparatus include the followings.

According to the present embodiment, the pressure-sensitive resistor 11, 12 includes a pressure-sensitive member having a resistance that changes according to an applied load. More specifically, as shown in FIG. 4, a resistance of the pressure-sensitive resistor 11, 12 can change in response to application of an operating force on the brake pedal to the pressure-sensitive resistors 11, 12 through the pressure receivers 110, 120. Although a conventional configuration requires a metal base for straining, the present configuration does not need to employ a metal base for straining. Consequently, according to the present embodiment, it becomes possible to downsize an element (e.g., pressure sensing element). Further, as shown in FIGS. 1 to 3, the pressure-sensitive resistors 11, 12 and the load detection IC are arranged on the same ceramic printed circuit board 10. It is therefore possible to downsize a load detection apparatus 1 that detects, for example, an operating force on a brake pedal of a vehicle.

Further, as shown in FIGS. 1 and 2, the load detection apparatus 1 includes the temperature compensation resistor 13. The load detection IC 14 compensates temperature characteristics of resistances of the pressure-sensitive resistors 11, 12 based on a resistance of the temperature compensation resistor 13 and determines an applied load based on a change of temperature-compensated resistances. Thus, it is possible to suppress an influence of temperature characteristics of the pressure-sensitive resistors 11 and 12. The load detection apparatus 1 therefore can detect a load precisely.

Further, as shown in FIGS. 1 and 2, the load detection apparatus 1 includes two pressure-sensitive resistors 11 and 12. The load detection IC 14 detects an applied load based on a change in resistance of the pressure-sensitive resistors 11 and 12. It is therefore possible to suppress an influence of a variation in resistance of a pressure-sensitive resistor and an influence of a variation in applying a load to a pressure-sensitive resistor, compared to a case where a single pressure-sensitive is employed.

Further, as shown in FIGS. 1 to 4, the pressure-sensitive resistors 11 and 12 are formed on the same surface of the ceramic printed circuit board 10. Accordingly, the load detection apparatus 1 can precisely detect a load applied in the same direction. For example, the load detection apparatus 1 can detect loads applied in the upward and downward detections.

Further, as shown in FIG. 2, the pressure-sensitive resistors 11 and 12 are line-symmetric about the axis “S” of symmetry. Thus, the pressure-sensitive resistors 11, 12 can receive the load uniformly. It is therefore possible to suppress an influence of a variation in application of the load to the pressure-sensitive resistors 11 and 12.

Further, in the present embodiment, the load detection IC 14 is used as a load detection circuit that determines an applied load based on a change in resistance of a pressure-sensitive resistor 11, 12. It is therefore possible to downsize a load detection apparatus. Moreover, the load detection IC 14 is mounted to a place on the axis “S” of symmetry. Thus, a wiring pattern for connecting the pressure-sensitive resistors 11, 12 with the load detection IC 14 can have a generally line-symmetric shape about the axis “S” of symmetry. It is possible to suppress an influence of a variation in noise from outside.

Further, the load detection IC 14 is mounted between the pressure-sensitive resistors 11 and 12. Thus, the wiring pattern for connecting the pressure-sensitive resistors 11, 12 with the load detection IC 14 can be short. It is possible to suppress an influence of a variation in noise from outside. Moreover, it is possible to downsize a load detection apparatus 1.

(Modifications)

The above embodiment can be modified in various ways. Examples of modifications are described below.

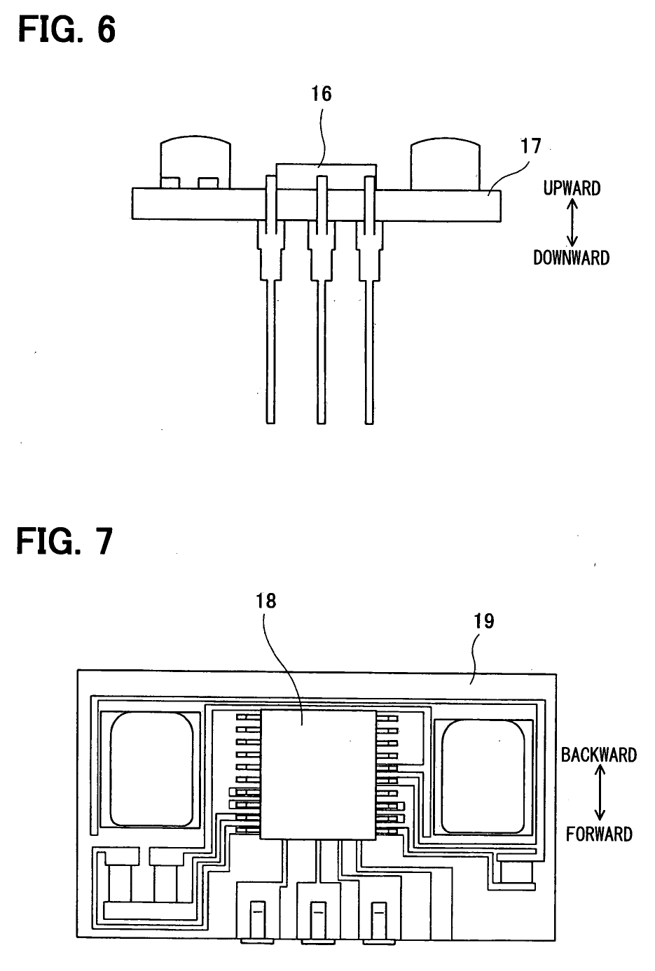

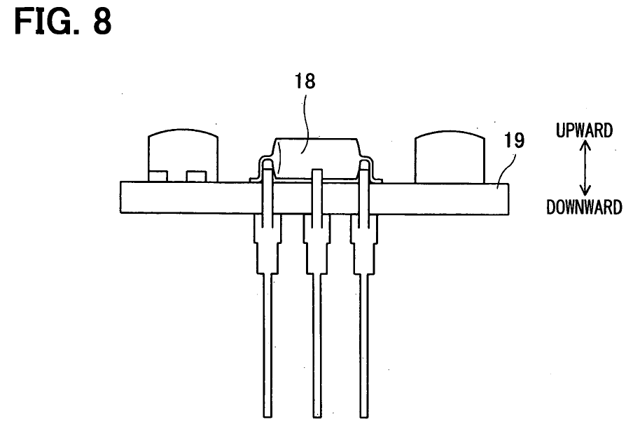

In the above embodiment, the load detection IC 14 includes a ceramic package. Alternatively, for example, as shown in FIGS. 5 and 6, a load detection IC may be a bare chip and may be connected with a wiring pattern of a ceramic printed circuit board 17 by using a bonding wire 160. Alternatively, as shown in FIGS. 7 and 8, a load detection IC 18 may have a mold package and may be directly soldered to a wiring pattern of a ceramic printed circuit board 19.

In the above embodiment, the two pressure-sensitive resistors 11, 12 are formed in the same surface of the ceramic printed circuit board 10. Alternatively, three or more pressure-sensitive resistors may be employed. Alternatively, multiple pressure-sensitive resistors may be formed on different surfaces. When an even number of pressure-sensitive resistors is employed, the even number of pressure-sensitive resistors may be arranged in a line-symmetric manner in an axis of symmetry.

In the above embodiment, the axis “S” of symmetry passes through the center part of the ceramic printed circuit board 10 and is parallel to the lateral direction of the ceramic printed circuit board 10. The center part of the ceramic printed circuit board 10 is a center part with respect to the longitudinal direction of the ceramic printed circuit board 10. Alternatively, a ceramic printed circuit board may have an arbitrary shape. An axis of symmetry may pass through an arbitrary part. An axis of symmetry may have an arbitrary orientation.

In the above embodiment, the pressure-sensitive resistor 11, 12, which has a resistance that changes according to an applied load, is used. Alternatively, an element having an electric property that changes according to an applied may be used, wherein the electric property may be other than a resistance.

In the above embodiment, the pressure-sensitive resistor 11, 12 senses an operation force on a brake pedal of a vehicle. Alternatively, for example, a load detection apparatus may be used in a vehicle to detect an operation force on a gas pedal, a load on a rack end in a steering system, or the like.

In the above embodiment, the pressure-sensitive resistors 11, 12 are formed so as to be line-symmetric about the axis “S” of symmetry. Further, the load detection IC 14 is mounted between the pressure-sensitive resistors 11, 12 and located on the axis “S” of symmetry. Alternatively, for example, pressure-sensitive resistors may be formed so that the pressure-sensitive resistors arranged in a point-symmetric manner about a point of symmetry on a ceramic printed circuit board. In such a case, a load detection IC may be mounted on the point of symmetry. A load detection IC may be mounted between pressure-sensitive resistors.

According to a first aspect of the above embodiments, an apparatus for detecting a load is provided. The apparatus includes a printed circuit board having a wiring pattern. The apparatus further includes a load sensing element arranged on the printed circuit board 10, 17, 19 and including a pressure-sensitive member. The. pressure-sensitive member has an electric property that is changeable according to the load applied to the pressure-sensitive member. The apparatus further includes a load detection circuit arranged on the printed circuit board, connected with the load sensing element through the wiring pattern of the printed circuit board, and configured to detect the load based on a change in the electric property of the load sensing element.

According to a second aspect of the above embodiments, an apparatus for detecting a load is provided. The apparatus includes a ceramic printed circuit board having first and second surface opposite to each other. The ceramic printed circuit board includes first and second resistor layers each located on the first surface of the ceramic printed circuit board. Each of the first and second resistor layers has a resistance that is changeable according to the load applied thereto and temperature thereof. The ceramic printed circuit board includes a third resistor layer located on the first surface of the ceramic printed circuit board and having a resistance that is changeable according to temperature thereof. The apparatus further includes first and second pressure receivers. The first and second pressure receivers are respectively coupled with the first and second pressure-sensitive resistor layers, and are configured to receive the load from outside and apply the received load to the first and second pressure-sensitive resistor layers, respectively. The apparatus further includes a load detection IC mounted onto the first surface of the ceramic printed circuit board so that first and second pressure-sensitive resistor layers are arranged in a symmetric manner about the load detection IC. The load detection IC is electrically connected with the first and second pressure-sensitive resistor layers and the temperature compensating resistor layer. The load detection IC is is configured to detect the load based on a change in resistance of the first and second pressure-sensitive resistor layers while compensating the change in resistance of the first and second pressure-sensitive resistor layers based on a change in resistance of the temperature compensating resistor layer.

While the invention has been described above with reference to various embodiments thereof, it is to be understood that the invention is not limited to the above described embodiments and construction. The invention is intended to cover various modifications and equivalent arrangements. In addition, while the various combinations and configurations described above are contemplated as embodying the invention, other combinations and configurations, including more, less or only a single element, are also contemplated as being within the scope of embodiment.

What is claimed is:

1. An apparatus for detecting a load, comprising:
a printed circuit board having a wiring pattern;
a load sensing element located on the printed circuit board and including a pressure-sensitive member, the pressure-sensitive member having an electric property that is changeable according to the load applied to the pressure-sensitive member; and
a load detection circuit arranged on the printed circuit board, connected with the load sensing element through the wiring pattern of the printed circuit board, and configured to detect the load based on a change in the electric property of the load sensing element.

2. The apparatus according to claim 1, further comprising:
a temperature compensation element located on the printed circuit board and has an electric property that is changeable according to temperature of the temperature compensation element,
wherein:
the load detection circuit is configured to compensate the change in the electric property of the load sensing element based on a change in the electric property of the temperature compensation element.

3. The apparatus according to claim 1, wherein:
the load sensing element includes a plurality of load sensing elements.

4. The apparatus according to claim 3, wherein:
the plurality of load sensing elements is located on a same surface of the printed circuit board.

5. The apparatus according to claim 3, wherein:
the plurality of load sensing elements is arranged in a line-symmetric manner about an axis of symmetry that is located on the printed circuit board.

6. The apparatus according to claim 1, wherein:
the load detection circuit is a load detection IC mounted to the printed circuit board.

7. The apparatus according to claim 5, wherein:
the load detection circuit is a load detection IC; and
the load detection IC is mounted on the printed circuit board so that the load detection IC is on the axis of symmetry.

8. The apparatus according to claim 7, wherein:
the plurality of load sensing element includes a first load sensing element and a second load sensing element; and
the load detection IC is mounted between the first load sensing element and the second load sensing element.

9. The apparatus according to claim 7, wherein:
the load is one of;
an operating force on a brake pedal of a vehicle:
an operating force on a gas pedal of a vehicle; and
a load on a rack end.

10. The apparatus according to claim 2, wherein:
the electric property of each of the pressure sensing element and the temperature compensation element is a resistance; and
the each of the pressure sensing element and the temperature compensation element includes a printed resistor layer on the printed circuit board.

11. The apparatus according to claim 10, wherein
the pressure sensing element and the temperature compensation element are made of a same material.

12. The apparatus according to claim 11, further comprising:
a pressure receiver fixed to the load sensing element and having a height to receive the load from an external load transmission element,
wherein:
the pressure receiver is configured to apply the received load to the load sensing element while inhibiting application of the received load to the temperature compensation element.

13. The apparatus according to claim 12, wherein:
the load detection circuit is configured to detect the load based on a change in the resistance of the load sensing element while compensating the sensed resistance of the load sensing element based on a change in the resistance of the temperature compensating element.

14. The apparatus according to claim 1, wherein
the printed circuit board is a ceramic printed circuit board.

15. An apparatus for detecting a load, comprising:
a ceramic printed circuit board having first and second surface opposite to each other, the ceramic printed circuit board including:
first and second resistor layers each located on the first surface of the ceramic printed circuit board and each having a resistance that is changeable according to the load applied thereto and temperature thereof; and
a third resistor layer located on the first surface of the ceramic printed circuit board and having a resistance that is changeable according to temperature thereof;
first and second pressure receivers respectively coupled with the first and second pressure-sensitive resistor layers, the first and second pressure receivers being configured to receive the load from outside and apply the received load to the first and second pressure-sensitive resistor layers, respectively; and
a load detection IC mounted onto the first surface of the ceramic printed circuit board so that first and second pressure-sensitive resistor layers are arranged in a symmetric manner about the load detection IC,
the load detection IC being electrically connected with the first and second pressure-sensitive resistor layers and the temperature compensating resistor layer,
the load detection IC being configured to detect the load based on a change in resistance of the first and second pressure-sensitive resistor layers while compensating the change in resistance of the first and second pressure-sensitive resistor layers based on a change in resistance of the temperature compensating resistor layer.
